(19) United States
(12) Patent Application Publication
(10) Pub. No.: US 2009/0068983 A1
(43) Pub. Date: Mar. 12, 2009

(54) Advertising-based Wireless Solutions

(76) Inventor: Lawrence A. Sessum, III, (US)

Correspondence Address: Lawrence A. Sessum III, 19 Decker Street, Buffalo, NY, 14215, US

(21) Appl. No.: 11/769,118

(22) Filed: Sep. 7, 2007

(51) Int. Cl. H04M 15/00

(52) U.S. Cl. 455/408

(57) ABSTRACT

The innovative part of “Advertising-based Wireless Solutions” is in the convenience of saving the consumer money. A large number of consumers enjoy saving money on the monthly bills and most times, love being rewarded for participating in customer initiatives such as this subscription service. Through this service, the customer would save a significant percentage of money off of their monthly service bill because they chose to allow their wireless device to be used as a portal for consumer communication and advertisement.

For every one hundred dollars we receive in advertising funding from a company, six customers will save ten percent off their wireless phone bills. This will continue for as long as they are a subscriber to this service. In the case the customer chooses to unsubscribe or switch companies, either activity can be arranged by simply contacting their wireless provider and making the change to their account.

### REFERENCE TO RELATED APLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE OR A COMPUTER PROGRAM LISTING COMPACT DISC APPENDIX

“Not Applicable”

### BACKGROUND OF THE INVENTION

In previous applications, the “ringback tone” has given consumers the opportunity to share with the world their favorite song or artist, so when someone called their phone, instead of hearing the normal “ring” they heard a musical selection or their favorite band talking.

### BRIEF SUMMARY OF THE INVENTION

“Advertising-based Wireless Solutions” is a phone subscription service that utilizes the “ringback tone” and takes this popular technology and utilizes it for the sake of business and advertisement. As an added bonus to the customer, they save a significant percentage of money off their wireless bill.

### BRIEF DESCRIPTION OF THE SEVERAL VIEWS OF THE DRAWING

“Not Applicable”

### DETAILED DESCRIPTION OF THE INVENTION

This is a detailed account of how the “Advertising-Based Wireless” Solution service works. The mobile service provider makes the announcement that they will be offering customer with new ways to cut costs and save money on their phone bills as part of a new consumer incentive. The customer decides to subscribe. The mobile provider will then provide a list of participating companies that have given to this service in expectation that their service will be advertised through the mobile waves. The customer will then choose the company they would like to allow to be heard on their phone. A customer may choose up to three participating companies.

Next, the service is applied to the consumers account. They must have upheld a subscription for an entire billing period for the change to be applied to their account. For every one hundred dollars received in advertising money from participating companies, six customers will save ten percent off of their phone bill for each company they choose. In other words, if customer account number 66537 chooses three business, that account will save thirty percent at the end of their billing period. Ten percent for each business.

This service offers a great way to fill the void in the marketing industry and show wireless consumers that there is someone listening to their cries of “high-cost” wireless service. “Ringback” tones can cost anywhere from ninety-nine cents to almost three dollars. Instead of paying for this service, like with a “ringback” tone, this service takes care of the consumer.

1. Advertising-based wireless solutions is a new service that utilizes the ever popular “ring-back” tone as a marketing tool for companies, restaurants, business and more. Through this service, a wireless customer is given the opportunity to allow a business to advertise on their phone, so when a friend or family member calls the customer, instead of a ‘ring’ or music, the friend or family member will hear an advertisement for that particular business or company. As an added part to this service, the customer will save a percentage off their monthly service bill.
